(19) United States
(12) Patent Application Publication
(10) Pub. No.: US 2025/0260145 A1
(43) Pub. Date: Aug. 14, 2025

(54) BATTERY MODULE AND BATTERY PACK INCLUDING THE SAME

(71) Applicant: Samsung SDI Co., Ltd., Yongin-si (KR)

(72) Inventor: Yusik HWANG, Yongin-si (KR)

(21) Appl. No.: 18/761,052

(22) Filed: Jul. 1, 2024

(30) Foreign Application Priority Data
Feb. 8, 2024 (KR) 10-2024-0019544

(51) Int. Cl. H01M 50/583; H01M 50/204; H01M 50/507; H01M 50/517; H01M 50/569

(52) U.S. Cl. CPC H01M 50/583; H01M 50/204; H01M 50/507; H01M 50/517; H01M 50/569

(57) ABSTRACT

A battery module includes a battery array including two or more cell rows in each of which unit cells are arranged along a first direction, the two or more cell rows being arranged along a second direction perpendicular to the first direction; and a busbar assembly including busbars connecting unit cells in each of the two or more cell rows and a busbar holder that fixes the busbars. Further, the battery module includes a fuse bar disposed onto the busbar holder at a boundary region of the two or more cell rows to electrically connect row connecting cells that are unit cells of adjacent cell rows in the second direction, and to block an overcurrent exceeding a set value from being drawn to the adjacent cell row, and a fixing unit that fixes the fuse bar to the busbar holder at the boundary region.

### CROSS-REFERENCE TO RELATED APPLICATION

The present application claims priority to and the benefit of Korean Application No. 10-2024-0019544, filed on Feb. 8, 2024, in the Korean Intellectual Property Office, the entire disclosure of which is incorporated herein by reference.

### BACKGROUND

### 1. Field

Aspects of embodiments of the present disclosure relate to a battery module and a battery pack including the battery module

### 2. Description of the Related Art

Due to the nature of charging and discharging secondary battery, there is a high risk of overheating and explosion. Therefore, battery modules that contain secondary batteries as unit cells come with various safety measures to prevent overheating and explosion.

Lithium battery modules, which contain lithium secondary batteries with a high energy density per unit weight as unit cells, have a variety of safety measures installed with strict standards.

As one of these safety measures, in high-capacity energy storage systems such as automotive battery packs, which generate high output by connecting a plurality of battery modules in series, it is common to install a hybrid busbar (hereafter referred to as a fuse bar) that can connect the unit cells of adjacent battery modules in series and protect against an overcurrent or an inrush current.

The fuse bar is positioned in a boundary region of adjacent battery modules to electrically connect adjacent unit cells. The fuse bar may serve as a fuse, interrupting the current flow in response to an overcurrent exceeding a set current value being applied, thereby preventing adjacent battery modules from overheating or exploding due to the overcurrent.

Thus, in a battery pack including a plurality of battery modules, the electrical instability of any one battery module can be prevented from propagating to other adjacent battery modules, thereby increasing the safety of the battery pack.

However, the busbar holder that covers the top of the battery module and is connected with each busbar is not provided with a fixing unit to fix the fuse bar. Therefore, an additional fixing unit is separately manufactured to fix the fuse bar, and this fixing unit is then installed individually at the required location in the module boundary area to hole the fuse bar in place.

As a result, the time and cost of securing the fuse bar to the busbar holder are increased, leading to a decrease in the overall process efficiency of the battery module or battery pack.

The above information disclosed in this Background section is for enhancement of understanding of the background of the present disclosure, and therefore, it may contain information that does not constitute related (or prior) art.

### SUMMARY

Embodiments of the present disclosure provide a battery module including a fixing unit fixing the fuse bar to the busbar holder.

Furthermore, embodiments of the present disclosure provide a battery pack including the battery module.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

A battery module according to one embodiment of the present disclosure may include a battery array including at least two rows each having unit cells arranged in series along a first direction, wherein the rows are arranged in parallel along a second direction perpendicular to the first direction, a busbar assembly including busbars connecting the unit cells in each of the two or more cell rows and a busbar holder that fixes the busbars, a fuse bar on the busbar holder at a boundary region of adjacent cell rows to electrically connect unit cells of the adjacent cell rows in the second direction, and to block an overcurrent exceeding a set value from being drawn from one of the adjacent cell rows into the other one of the adjacent cell rows, and a fixing unit that fixes the fuse bar to the busbar holder at the boundary region.

According to one embodiment, the unit cells respectively may include, on their top surfaces, positive electrode terminals and negative electrode terminals that are positioned to be spaced apart from each other in the second direction, and wherein, in each of the at least two cell rows, the positive electrode terminals and the negative electrode terminals are alternately arranged in the first direction.

According to one embodiment, the busbars may be arranged to connect the positive electrode terminals and the negative electrode terminals of adjacent unit cells of the unit cells in the first direction to serially connect the unit cells.

According to one embodiment, the fuse bar may be connected to the positive electrode terminal of one of the adjacent unit cells and the negative electrode terminal of the other adjacent unit cells to thereby serially connect the adjacent cell rows.

According to one embodiment, the fuse bar may include a fuse terminal including a fuse that is connected to the positive terminal of one of the adjacent cells and is configured to be cut by the overcurrent, a detection resistor that is connected to the negative terminal of the other of the adjacent cells, a fuse controller that is configured to detect an intensity of current being applied to the adjacent cells from the detection resistor and to selectively generate a fuse operation signal based on the intensity of the applied current, and a fuse driver that drives the fuse terminal to cut the fuse in response to the fuse operation signal.

According to one embodiment, the fixing unit may be engaged with a pair of fixing side portions of the fuse bar which are symmetrically positioned along the first direction, thereby fixing the fuse bar to a boundary holder serving as the busbar holder located at the boundary region.

According to one embodiment, the fixing unit may include a flat plate rib having a pair of plate blocks that are fixed to the boundary holder and engaged with the pair of side portions of the fuse bar, and the fuse bar may be in a space between the pair of plate blocks.

According to one embodiment, each of the plate blocks may include a body that is secured to the boundary holder, a pair of fixing protrusions that protrude along the first direction from a periphery of the body and provide a rib receiving recess therebetween, and fixing members that protrude through at least one of the pair of fixing protrusions and the body to be fixed to the boundary holder. The fuse bar includes receiving grooves that are formed at the fixing side portions to correspond in position to the pair of fixing protrusions, and a fuse receiving end that defines the receiving grooves and is received in the rib receiving recess.

According to one embodiment, the fixing members may include bolts that are fastened to the boundary holder.

According to one embodiment, the fixing unit may include a transfer rib having a pair of transfer blocks that are configured to move linearly along guide rails extending along opposite edges of the boundary holder in the first direction to engage with each of the fixing side portions of the fuse bar on the boundary holder.

According to one embodiment, each of the transfer blocks may include a body, a pair of fixing protrusions that protrude along the first direction from a periphery of the body and provide a rib receiving recess therebetween, and drive members that are fixed to respective rear surfaces of the body and the pair of fixing protrusions to engage with the guide rails and move the body and the pair of fixing protrusions along the first direction. The fuse bar includes receiving grooves at the fixing side portions to correspond in position to the pair of fixing protrusions, and a fuse receiving end that defines the receiving grooves and is received in the rib receiving recess.

According to one embodiment, the guide rails may be on the opposite edges of the boundary holder, the drive members may have end grooves at opposite sides of at least one of the pair of fixing protrusions and the body, and the drive members may receive the guide rails in their respective end grooves at the opposite edges of the boundary holder.

According to one embodiment, each of the guide rails may include a fixing hook coupled to an end of the corresponding guide rail, and the transfer rib may include a hook receiving recess receiving the fixing hook. The transfer rib is fixed to the guide rails by engagement of the fixing hook and the hook receiving recess.

According to one embodiment, the hook receiving recess may include a channel guide linearly recessed along the first direction from a lower outer surface of each of the pair of fixing protrusions and defined by a channel wall, a hook groove provided at an end of the channel guide that is in communication with the channel guide and has a size larger than the channel guide, and a locking protrusion that is a step with respect to the channel guide and is configured to prevent separation of the fixing hook received in the hook groove.

According to one embodiment, the fixing hook may include a channel burying portion that is buried in the channel guide and a wing disposed at an end of the channel burying portion. The wing has a variable thickness and is received in the hook groove.

According to one embodiment, a thickness of the channel wall may be configured to be substantially equal to a gap between each of the guide rails and the channel burying portion.

A battery pack according to one embodiment of the present disclosure may include battery modules arranged in a lower housing and electrically connected to each other and an upper housing coupled to the lower housing to separate the battery modules from the outside. Each of the battery modules includes a battery array including at least two cell rows each including unit cells arranged in series along a first direction. The two or more cell rows are arranged in parallel along a second direction perpendicular to the first direction. Each of the battery modules also includes a busbar assembly including busbars connecting the unit cells in each of the two or more cell rows and a busbar holder that fixes the busbars, a fuse bar on the busbar holder at a boundary region of adjacent cell rows of the two or more cell rows to electrically connect adjacent cell units in the second direction, and to block an overcurrent exceeding a set value from being drawn from one of the adjacent cell units into the other one of the adjacent cell units, and a fixing unit that fixes the fuse bar to the busbar holder at the boundary region.

According to one embodiment, the fixing unit may be engaged with a pair of fixing side portions of the fuse bar which are symmetrically positioned along the first direction, thereby fixing the fuse bar to a boundary holder at the boundary region.

According to one embodiment, the fixing unit may include a flat plate rib having a pair of plate blocks that are fixed to the boundary holder and engaged with the pair of side portions of the fuse bar, and the fuse bar is in a space between the pair of plate blocks.

According to one embodiment, the fixing unit may include a transfer rib having a pair of transfer blocks that are configured to move linearly along guide rails extending along opposite edges of the boundary holder in the first direction, to engage with each of the fixing side portions of the fuse bar on the boundary holder.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a perspective view illustrating a battery module according to one embodiment of the present disclosure;

FIG. 2 is a perspective view illustrating a busbar assembly of the battery module shown in FIG. 1;

FIG. 3 is a perspective view illustrating the connection state of busbars and unit cells of the battery module shown in FIG. 1;

FIG. 4 is a perspective view illustrating a unit cell of the battery module shown in FIG. 1;

FIG. 5 is a cross-sectional view of the unit cell shown in FIG. 4 taken along a line a-a′ of FIG. 4;

FIG. 6 is diagram illustrating a configuration of the fuse bar shown in FIG. 2;

FIG. 7 is a circuit diagram of the fuse bar shown in FIG. 6;

FIG. 8 is a plan view illustrating the fixing unit for fixing the fuse bar shown in FIG. 6 to the busbar holder according to one embodiment of the present disclosure;

FIG. 9 is a perspective view illustrating the fixing unit according to one embodiment of the present disclosure;

FIG. 10 is a plan view illustrating a shape of the fuse bar shown in FIG. 8;

FIGS. 11 and 12 are plan views illustrating a fixing unit for fixing the fuse bar shown in FIG. 6 to a busbar holder according to another embodiment of the present disclosure;

FIG. 13 is a perspective view illustrating the fixing unit shown in FIGS. 11 and 12;

FIG. 14 is a cross-sectional view illustrating a state in which the fixing unit is fixed by a fixing hook according to one embodiment of the present disclosure;

FIG. 15 is a top perspective view showing a battery pack including the battery module shown in FIG. 1; and

FIG. 16 is a rear perspective view showing the battery pack including the battery module shown in FIG. 1.

### DETAILED DESCRIPTIONS

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

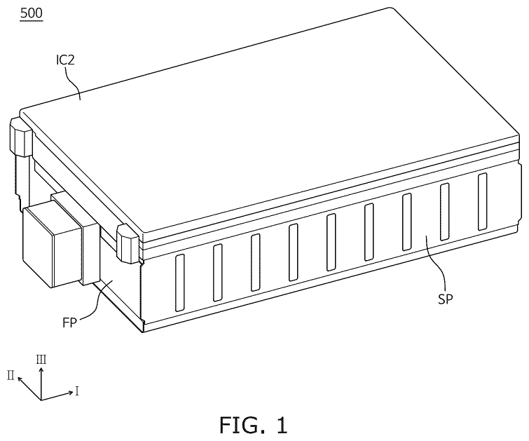

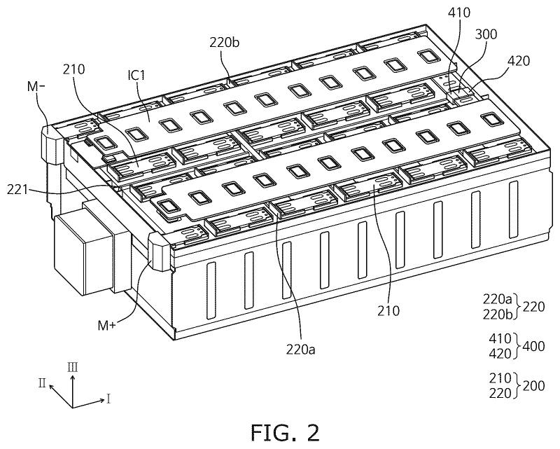

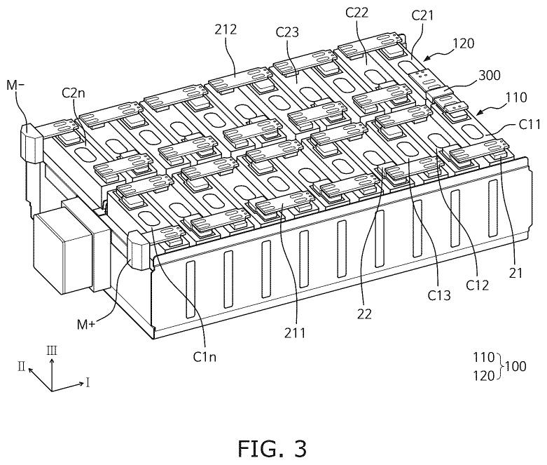

FIG. 1 is a perspective view illustrating a battery module 500 according to one embodiment of the present disclosure, and FIG. 2 is a perspective view illustrating a busbar assembly 200 of the battery module 500 shown in FIG. 1. FIG. 3 is a perspective view illustrating the connection state of busbars and unit cells of the battery module 500 shown in FIG. 1.

Referring to FIGS. 1 to 3, a battery module 500 according to one embodiment of the present disclosure may include a battery array 100 including at least one pair of a first cell row 110 and a second cell row 120, a busbar assembly 200, a fuse bar 300 configured to block overcurrent application (delivery) between the first cell row 110 and the second cell row 120, and a fixing unit 400 configured to couple (fix) the fuse bar 300 to the busbar assembly 200.

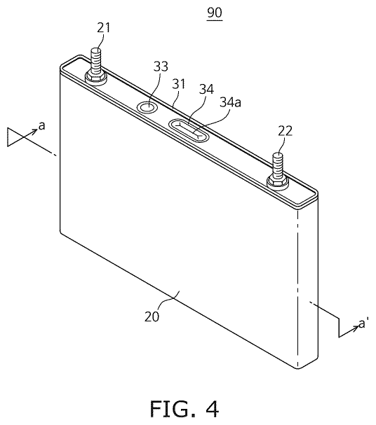

In one embodiment, the battery array 100 may include a plurality of unit cells (90 in FIG. 4) arranged sequentially along a first direction I on a bottom plate (not shown) of the battery module 500. Each unit cell has a width along the first direction I and a length along a second direction II perpendicular to the first direction I.

In one or more embodiments, a plurality of unit cells 90 may be arranged one after another along the first direction I to form each of a first cell row 110 and a second cell row 120, and the first cell row 110 and the second cell row 120 may be arranged adjacent to each other along the second direction II (e.g., the unit cells 90 may be arranged in a grid).

Accordingly, the first cell row 110 may include first to n-th unit cells C11 to C1n arranged along the first direction I, and the second cell row 120 may include first to n-th unit cells C21 to C2n arranged along the first direction I.

Thus, the battery array 100 may include the plurality of unit cells 90 arranged in a matrix or grid shape along the first direction I and the second direction II (i.e., the unit cells 90 are arranged in the first cell row 110 and the second cell row 120).

In one or more embodiments, each unit cell 90 may be a rechargeable secondary battery having a positive electrode plate 11 and a negative electrode plate 12 separated by a separator 13. Each unit cell 90 is configured to enable reversible charging and discharging.

After arranging the plurality of unit cells 90 to be aligned in the matrix shape, the battery array 100 may be completed by placing a front-end plate FP on a front side, a rear end plate (not shown) on a rear side, and side plates SP on sides.

After placing the busbar assembly 200 and an insulating cover IC1 above the battery array 100, an insulating case IC2 is placed over them. A top plate (not shown) covering the insulating case IC2 (see FIG. 1) may be placed to couple with the front-end plate FP, the rear end plate, and the side plates SP to complete the battery module 500 that is isolated from the outside.

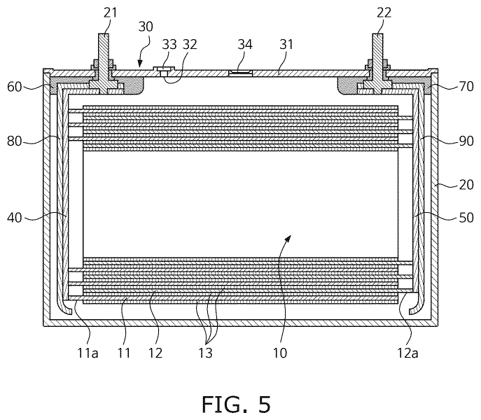

FIG. 4 is a perspective view illustrating a unit cell 90 of the battery module 500 shown in FIG. 1, and FIG. 5 is a cross-sectional view of the unit cell 90 shown in FIG. 4 taken along a line a-a′ of FIG. 4.

Referring to FIGS. 4 and 5, the unit cell 90 may be a secondary battery including at least one electrode assembly 10 formed by winding or stacking a positive electrode plate 11 and a negative electrode plate 12 with a separator 13 serving as an insulator between the positive electrode plate 11 and the negative electrode plate 12, a housing can 20 in which the electrode assembly 10 is accommodated, and a cap assembly 30 coupled to an opening of the housing can 20.

Hereinafter, a prismatic lithium-ion secondary battery is described as an embodiment of the secondary battery. However, the present disclosure is not limited thereto, and the present disclosure includes any other suitable type and shape of battery, such as lithium polymer batteries or cylindrical batteries.

The positive and negative electrode plates 11 and 12 may include coated regions, and positive and negative electrode uncoated regions 11a and 12a, respectively. In each of the coated regions, an active material is coated onto a current collector formed of a thin metal foil. In each of the positive and negative electrode uncoated regions 11a and 12a, an active material is not present.

The positive electrode plate 11 and the negative electrode plate 12 are wound with the separator 13 serving as the insulator therebetween. However, the present disclosure is not limited thereto, and the electrode assembly 10 described above may have a structure in which multiple positive and negative electrodes made of sheets are stacked in alternating manner with separators therebetween.

The housing can 20 may form the overall appearance of the secondary battery (e.g., the unit cell 90) and may include a conductive metal such as aluminum, an aluminum alloy, or nickel-plated steel. Additionally, the housing can 20 may provide a space in which the electrode assembly 10 is accommodated.

The cap assembly 30 may include a cap plate 31 covering the opening of the housing can 20, and each of the housing can 20 and the cap plate 31 may be made of or include a conductive material. The positive and negative electrode terminals 21 and 22 may be electrically connected to the positive and negative electrode plates 11 and 12, respectively, and the positive and negative electrode terminals 21 and 22 may protrude outwardly through the cap plate 31.

In one or more embodiments, the positive electrode terminal 21 and the negative electrode terminal 22 may be at opposite ends of the housing can 20 in the second direction and may both protrude outwardly through the cap plate 31.

In one or more embodiments, as shown in FIG. 3, a pair of unit cells 90 aligned along the second direction II may be arranged in the sequence of the positive electrode terminal 21, the negative electrode terminal 22, the positive electrode terminal 21, and the negative electrode terminal 22. Additionally, the unit cells 90 aligned along the first direction I may have the positive electrode terminals 21 and the negative electrode terminals 22 alternately arranged.

Accordingly, the unit cells 900 are connected in series by a busbar 210, which will be described later, so that the plurality of unit cells 90 function as a single energy source with increased output.

The cap plate 31 may be a thin plate coupled to the opening of the housing can 20. Further, the cap plate 31 may have an electrolyte injection hole 32 in which a sealing stopper 33 may be located, and a vent 34 with a notch 34a.

The positive and negative electrode terminals 21 and 22 may be electrically connected to the positive and negative electrode current collectors 40 and 50, respectively, that are coupled (e.g., welded) to the positive and negative electrode uncoated regions 11a and 12a, respectively. In one or more embodiments, the positive and negative electrode terminals 21 and 22 may be coupled (e.g., welded to) or integrally coupled with the positive and negative electrode current collectors 40 and 50, respectively.

The positive and negative electrode terminals 21 and 22 coupled (e.g., welded) to the positive and negative electrode current collectors 40 and 50, respectively, may be coupled to first and second lower insulating members 60 and 70, respectively, and one end of each of first and second separating members 80 and 90, respectively.

In one or more embodiments, eleven unit cells 90 may be arranged in each of the first cell row 110 and the second cell row 120, resulting in a total of twenty-two unit cells 90. However, this is merely one embodiment of the present disclosure, and the number of unit cells 90 may vary depending on the desired capacity of the battery module 500.

In one embodiment, the busbar assembly 200 may be on top of the battery array 100 to electrically connect the plurality of unit cells 90 to each other and to provide a fixed base for a control module (not shown) that controls each of the unit cells 90.

In one or more embodiments, the busbar assembly 200 may include a plurality of busbars 210 on top of the battery array 100 to connect the plurality of unit cells 90, and a plurality of flat plate-shaped busbar holders 220 to secure the plurality of busbars 210.

Each busbar 210 may be made of or include a conductive member that is coupled to electrode terminals 21, 22 of adjacent unit cells 90 and electrically connects the adjacent unit cells 90. In one or more embodiments, the busbar 210 may include a low-resistance metal plate configured to establish a connection with the positive electrode terminal 21 of one of unit cells 90 and the negative electrode terminal 22 of an adjacent one of the unit cells 90.

As shown in FIG. 3, the unit cells 90 are aligned such that the positive electrode terminals 21 and the negative electrode terminals 22 are alternately arranged along the first direction I and the busbars 210 are elongated flat plates extending along the first direction I and connecting the positive electrode terminals 21 and the negative electrode terminals 22 of adjacent unit cells 90 in the first direction I to each other. Consequently, the unit cells 90 in each of the first cell row 110 and the second cell row 120 are connected in series with each other.

The busbars 210 are on top of the battery array 100 and aligned in a line along the periphery of each of the first cell row 110 and the second cell row 120. The vent 34 may be exposed in the center of the unit cell 90 (e.g., the busbars 210 may not cover the vents 34).

A plurality of unit cells 90 arranged in the first cell row 110 may be connected to each other in series by a plurality of first busbars 211, and a plurality of unit cells 90 arranged in the second cell row 120 may be connected to each other in series by a plurality of second busbars 212.

The busbar holder 220 is a flat plate on the top of the battery array 100 to hold and fix the busbars 210, and various control units for controlling the battery module 500 may be on a top surface of the busbar holder 220.

In one or more embodiments, the busbars 210 are coupled (e.g., fixed) on the top surface of the busbar holder 220 at positions corresponding to positions of the positive electrode terminal 21 and the negative electrode terminal 22, and connection lines of the busbar 210 pass through the busbar holder 220 and are connected to the positive electrode terminal 21 and the negative electrode terminal 22.

Further, wiring lines, such as a circuit board, may be on the top surface of the busbar holder 220, and a battery management system (BMS) may be on the circuit board, for example, to control the individual unit cells 90.

In one or more embodiments, a boundary holder 221 serving as the busbar holder 220 may be located at a boundary region between the first cell row 110 and the second cell row 120. The boundary holder 221 may include a fuse bar 300 (to be described later) so that the unit cells 90 located adjacent to each other with the boundary holder 221 therebetween can be connected in series with each other by the fuse bar 300.

Accordingly, the first cell row 110 and the second cell row 120 may be connected in series by the fuse bar 300, and the unit cells 90 within each of the first cell row 110 and the second cell row 120 may be connected in series. Therefore, the battery module 500 may include the plurality of unit cells 90 connected in series.

In one embodiment, the fuse bar 300 is at the boundary holder 221 provided between the first cell row 110 and the second cell row 120 to electrically connect or short-circuit the first cell row 110 and the second cell row 120.

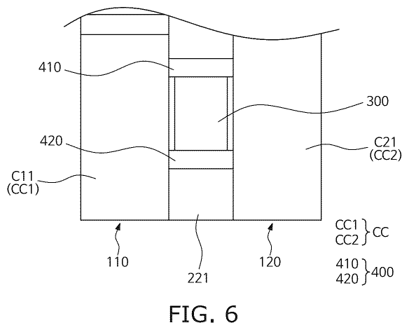

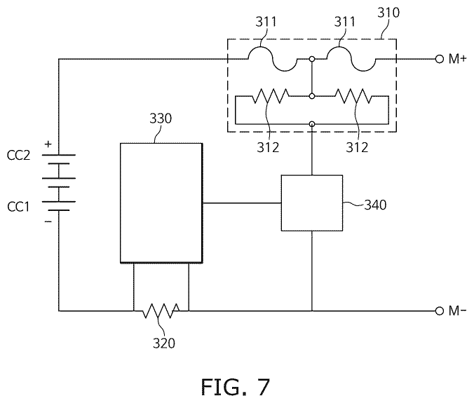

FIG. 6 is diagram illustrating a configuration of the fuse bar 300 shown in FIG. 2, and FIG. 7 is a circuit diagram of the fuse bar 300 shown in FIG. 6.

The fuse bar 300 is at the boundary holder 221 to electrically connect row connecting cells CC1 and CC2, which are the unit cells 90 adjacent to each other (the adjacent unit cells 90 in the second direction II) but are in different cells rows (i.e., a unit cell 90 in the first cell row 110 and an adjacent unit cell 90 in the second cell row 120), and to prevent an overcurrent or an inrush current exceeding a set value from being applied to the adjacent cell row CC1 or CC2.

The overcurrent may be caused by the penetration of a sharp metal object through the unit cell 90, or by the insulation breakdown between the positive electrode plate 11 and the negative electrode plate 12 due to the shrinkage of the separator 13 between the positive electrode plate 11 and the negative electrode plate 12. Rush current may be caused by an abnormality in the externally connected charging circuit or load.

In one or more embodiments, the fuse bar 300 may include a fuse terminal 310 (to be described later), which may cut a fuse in the fuse terminal 310 based on the intensity of the applied current, thereby disconnecting the electrical connection between the first cell row 110 and the second cell row 120.

In one or more embodiments, the positive electrode terminal 21 of the n-th unit cell C1n in the first cell row 110 may be an input terminal M+ for the entire battery module 500, and the negative electrode terminal 22 of the n-th unit cell C2n in the second cell row 120 may be the output terminal M-for the entire battery module 500.

Accordingly, the current supplied to the input terminal M+ flows from the n-th unit cell Cn in the first cell row 110 to the first unit cell C11 in the first cell row 110, and then the current flows to the first unit cell C21 in the second cell row 110 through the fuse bar 300. Subsequently, the current flows from the first unit cell C21 to the n-th unit cell C2n in the second cell row 120 and then is supplied to an external load through the output terminal M−.

In one or more embodiments, the first unit cell C11 of the first cell row 110 and the first unit cell C21 of the second cell row 120, which are connected to the fuse bar 300, are row connecting cells CC electrically connecting the first cell row 110 and the second cell row 120.

The row connecting cells CC may be any adjacent unit cells between the first cell row 110 and the second cell row 120. In one or more embodiments, the row connecting cells CC may be the first unit cell C11 of the first cell row 110 and the first unit cell C21 of the second cell row 120, which allows all the unit cells 90 of the first cell row 110 and the second cell row 120 to be connected.

In one or more embodiments, the first unit cell C11 of the first cell row 110 may be a first connection cell CC1 connected to the fuse bar 300, and the first unit cell C21 of the second cell row 120 may be a second connection cell CC2 connected to the fuse bar 300.

In one or more embodiments, the fuse bar 300 is connected to the negative electrode terminal 22 of the first connection cell CC1 and the positive electrode terminal 21 of the second connection cell CC2. Accordingly, all of the unit cells 90 of the battery module 500 may be connected in series.

In response to the applied current being an overcurrent exceeding a set intensity of current or a randomly generated inrush current, the fuse 311 provided in the fuse bar 300 may be cut to protect the unit cells 90 in the second cell row 120.

In one or more embodiments, the fuse bar 300 may include a fuse terminal 310, a detection resistor 320 configured to detect the magnitude of current applied to the row connecting cell (e.g., CC1 and/or CC2), a fuse controller 330 configured to detect the intensity of the applied current from the detection resistor 320 and to selectively generate a fuse operation signal based on the intensity of the applied current, and a fuse driver 340 configured to drive the fuse terminal 310 in response to the fuse operation signal.

The fuse terminal 310 may be on an operation line connecting the first connection cell CC1 and the second connection cell CC2 to the input terminal M+. A charging current or a discharging current may flow along the operation line.

The fuse terminal 310 includes a three-terminal element, two terminals of which are connected to the operation line through which the charging current or the discharging current flows, and one terminal of which is connected to the fuse driver 340. In one or more embodiments, the fuse terminal 310 may include a fuse 311 that is connected in series with the operation line and is configured to be fused and cut at a set temperature, and a fuse resistor 312 that applies or supplies heat to the fuse 311.

The fuse controller 330 may detect the occurrence of a safety factor, such as an overcurrent or an inrush current, by detecting a voltage across the detection resistor 320. In response to the intensity of the detected current exceeding a set value, the fuse controller 330 generates a fuse operation signal and transmits it to the fuse driver 340.

The applied overcurrent or the applied inrush current is directed to the fuse terminal 310 by the fuse driver 340 and applied to the fuse resistor 312. Consequently, the fuse 311 may be melted and cut by the heat generated from the fuse resistor 312. In this manner, the applied current having an intensity greater than the set value, which that is the overcurrent or the inrush current, may be blocked from being directed to the second cell row 120.

In one or more embodiments, a first holder 220a, which is the busbar holder 220 of the first cell row 110, has a larger resistance than a second holder 220b, which is the busbar holder 220 of the second cell row 120. Thus, the first holder 220a may have an increased resistance to the overcurrent or the inrush current compared to the second cell row 120. Accordingly, the inflow of the overcurrent or the inrush current to the second cell row 120, which has a relatively lower resistance, can be blocked.

In contrast, in an embodiment in which the input terminal M+ is in the second cell row 120, the resistance of the busbar holder 220 in the first cell row 110 may be smaller than that in the second cell row 120. Thus, the fuse bar 300 may be configured to block the inflow of the overcurrent or the inrush current into the first cell row 110.

In one embodiment, the fixing unit 400 may be fixed to the boundary holder 221 to stably couple the fuse bar 300 to the boundary holder 221.

The fuse bar 300 may be aligned (or substantially aligned) with the boundary holder 221 and coupled to the fixing unit 400 fixed to the boundary holder 221, thereby preventing (or at least mitigating) vibration or movement within the battery module 500. In one or more embodiments, the fixing unit 400 may include a pair of blocks 410 and 420 by which the fuse bar 300 is fixed to the boundary holder 221.

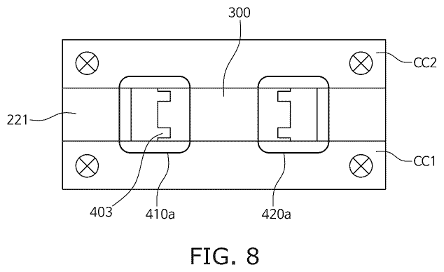

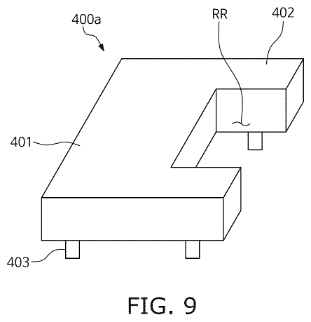

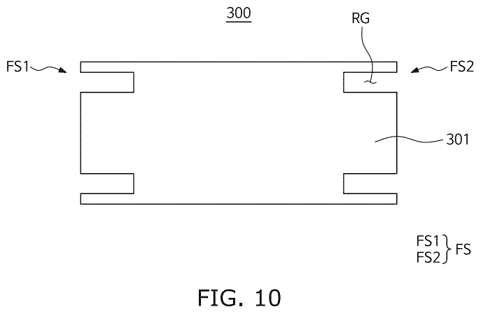

FIG. 8 is a plan view illustrating the fixing unit 400 for fixing the fuse bar 300 shown in FIG. 6 to the busbar holder according to one embodiment of the present disclosure, and FIG. 9 is a perspective view illustrating the fixing unit 400 according to one embodiment of the present disclosure. FIG. 10 is a plan view illustrating a shape of the fuse bar 300 shown in FIG. 8.

In FIGS. 8 to 10, the fixing unit 400 be a plate rib 400a and a pair of the blocks 410 and 420 may be a pair of first and second plate blocks 410a and 420a by which the fuse bar 300 is fixed to the boundary holder 221.

Referring to FIGS. 8 to 10, the fixing unit 400 according to one embodiment of the present disclosure may be the plate rib 400a that is fixed to the boundary holder 221 and engages with each of fixing side portions FS of the fuse bar 300, which are symmetrically (or substantially symmetrically) positioned along the first direction I. Since the plate rib 400a is fixed to the boundary holder 221, the fuse bar 300 may be fixed to the boundary holder 221 through the plate rib 400a.

In one or more embodiments, the plate rib 400a may include a pair of first and second plate blocks 410a and 420a at opposite ends of the fuse bar 300 (e.g., a first fixing side portion FS1 and a second fixing side portion FS2) that press the fuse bar 300. That is, the plate rib 400a may include a first plate block 410a engaging the fuse bar 300 at the first fixing side portion FS1 and a second plate block 420a engaging with the fuse bar 300 at the second fixing side portion FS2.

The first plate block 410a and the second flat plate block 420a may be fixed to the boundary holder 221 and spaced apart from each other in the first direction I. The fuse bar 300 may be inserted downward into a space between the first and second plate blocks 410a and 420a.

The first plate block 410a may include a body 401 coupled (e.g., secured) to the boundary holder 221, a pair of fixing protrusions 402 that protrude along the first direction I from the periphery of the body 401 (e.g., opposite sides or ends of the body 401) and provide a rib receiving recess RR between the fixing protrusions 402, and fixing members 403 that protrude through the body 401 or the fixing protrusions 402 and are coupled (e.g., fixed) to the boundary holder 221.

In one or more embodiments, the body 401 and the fixing protrusions 402 may be integral, and the fixing members 403 may penetrate through at least one of the fixing protrusions 402 and the body 401 from the top surface and be attached to the boundary holder 221. In one or more embodiments, each of the fixing members 403 may be a bolt that is fastened to the boundary holder 221.

In one or more embodiments, the fuse bar 300 may include receiving grooves RG at the fixing side portions FS that correspond in position to the fixing protrusions 402. The fuse bar 300 may also include fuse receiving ends 301 that define the receiving grooves RG and that are received in the rib receiving recess RR in the plate rib 400a.

Accordingly, the first plate block 410a and the fuse bar 300 may be coupled together in such a configuration that the fixing protrusions 402 are received in the receiving grooves RG and the fuse receiving end 301 is received in the rib receiving recess RR.

The second plate bock 410b may have substantially the same configuration as the first plate block 410a, and therefore further detailed description of the second plate block 410b will be omitted. Accordingly, the second plate block 410b and the fuse bar 300 may also be coupled together in such a configuration that the fixing protrusions 402 are received in the receiving grooves RG and the fuse receiving end 301 is received in the rib receiving recess RR of the second plate block 410b.

The first plate block 410a and the second plate bock 410b may be coupled (e.g., secured) to the boundary holder 221 by the fixing members 403, and the fuse bar 300 may be coupled between the pair of first plate block 410a and second plate bock 410b and coupled (e.g., secured) to the boundary holder 221.

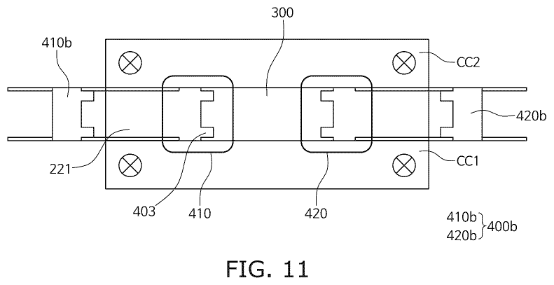

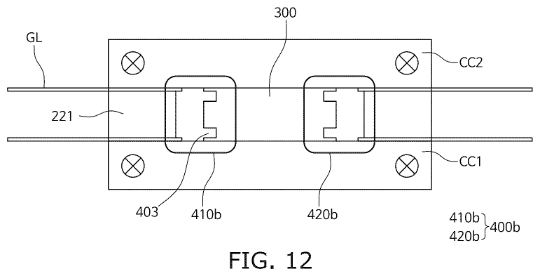

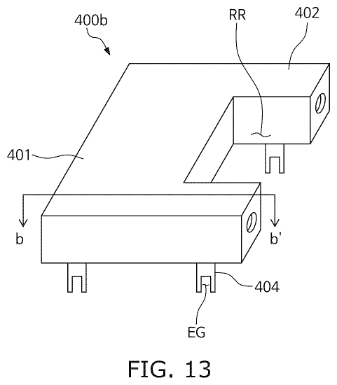

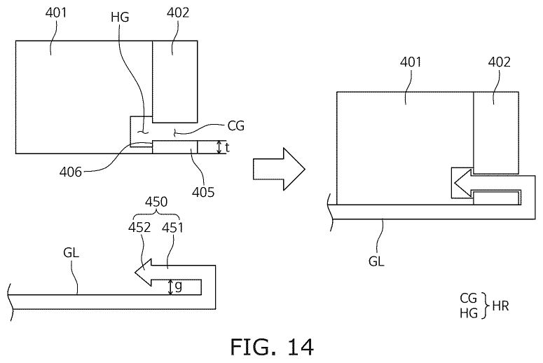

FIGS. 11 and 12 are plan views illustrating a fixing unit 400 for fixing the fuse bar 300 shown in FIG. 6 to a busbar holder according to another embodiment of the present disclosure, and FIG. 13 is a perspective view illustrating the fixing unit 40 shown in FIGS. 11 and 12. FIG. 14 is a cross-sectional view illustrating a state in which the fixing unit 400 is fixed by a fixing hook.

In FIGS. 11 to 14, the fixing unit 400 is a transfer rib 400b configured to move linearly along guide rails GL and a pair of the blocks 410 and 420 may be a pair of first and second transfer blocks 410a and 420a. The shape of the fuse bar 300 engaging with the transfer rib 400b is the same as the shape of the fuse bar 300 shown in FIG. 10. Therefore, further description of the shape of the fuse bar 300 will be omitted.

FIG. 11 is a diagram illustrating a state before the fuse bar 300 and the transfer rib 400b are engaged with each other, and FIG. 12 is a diagram illustrating a state after the fuse bar 300 and the transfer rib 400b are engaged with each other. FIG. 13 is a perspective view illustrating a fixing unit 400 shown in FIG. 11 and FIG. 12. FIG. 14 illustrates a configuration in which the fixing unit 400 shown in FIG. 13 is cut along a b-b′ direction and engaged with a fixing hook.

Referring to FIGS. 11 to 14, the transfer rib 400b may be configured to move linearly along the guide rails GL extending along the opposite edges of the boundary holder 221 in the first direction I to engage with the fixing side portion FS.

Accordingly, the transfer rib 400b may linearly move from the outside of the boundary holder 221 towards the boundary holder 221 to engage with the fixing side portion FS of the fuse bar 300 on the boundary holder 221. Thus, the transfer rib 400b may include a first transfer block 410b configured to engage with the fuse bar 300 at a first fixing side portion FS1 and a second transfer block 420b configured to engage with the fuse bar 300 at a second fixing side portion FS2.

In one or more embodiments, the first transfer block 410b may include a body 401, a pair of fixing protrusions 402 that protrude along the first direction I from the periphery of the body 401 (e.g., opposite sides or ends of the body 401) and a rib receiving recess RR between the pair of fixing protrusions 402, and a drive member 404 coupled (e.g., fixed) to respective rear surfaces of the body 401 and the fixing protrusions 402 to engage with the guide rails GL and move the body 401 and the fixing protrusions 402 along the first direction I.

The body 401 and the fixing protrusions 402 may have substantially the same configuration as the body 401 and the fixing protrusions 402 of the plate rib 400a described with reference to FIG. 9, and therefore they will not be described in further detail.

The drive member 404 may be on a rear surface of at least one of the fixing protrusions 402 and/or the body 401. The drive member 404 may be configured to engage with the guide rails GL to move linearly along the guide rails GL.

In one or more embodiments, at least a pair of drive members 404 may protrude from the respective rear surfaces of both sides of the body 401 and the fixing protrusions 402, and each drive member 404 may have an end groove EG at an end thereof configured to receive one of the guide rails GL.

The guide rails GL may be positioned on each edge of the boundary holder 221 and extend to the outside of the boundary holder 221. Consequently, the pair of drive members 404 may receive the guide rails GL in their respective end grooves EG to linearly move along the guide rails GL from the outside of the boundary holder 221 to the fuse bar 300.

The movement of the drive members 404 causes the body 401 and the fixing protrusions 402 to move linearly along the guide rails GL.

The second transfer block 420b may have substantially the same configurations as the first transfer block 410b, and therefore any further detail descriptions of the second transfer block 420b will be omitted.

After aligning the fuse bar 300 with the boundary holder 221 to determine a fixed position, the first transfer block 410b and the second transfer block 420b are respectively engaged with the guide rails GL that extend to the outside.

Subsequently, the aligned fuse bar 300 may be engaged with the first transfer block 410b and the second transfer block 420b at the opposite ends thereof by moving the first transfer block 410b and the second transfer block 420b along the guide rail GL. In this manner, the fuse bar 300 may be secured to the boundary holder 221.

Once the engagement of the first transfer block 410b and the second transfer block 420b with the fuse bar 300 is completed, the fixing hook 450 (see FIG. 14) may be engaged with the first transfer block 410b and the second transfer block 420b to secure the fuse bar 300.

The fixing hook 450 may be positioned at an end of each guide rail GL and may be configured to engage with a hook receiving recess HR of the first transfer block 410b. Accordingly, due to the engagement of the fixing hook 450 and the hook receiving recess HR, the first transfer block 410b can be secured to the guide rail GL.

In one or more embodiments, the hook receiving recess HR may include a channel guide CG that is linearly recessed along the first direction I from a lower outer surface of the fixing protrusion 402 and defined by a channel wall 405, and a hook groove HG at an end of the channel guide CG that is in communication with the channel guide CG and has a size larger than the channel guide CG.

In one or more embodiments, the width of the channel guide CG is smaller than the width of the hook groove HG. Thus, a stepped surface is provided between the hook groove HG and the channel guide CG. The stepped surface having a step with respect to the channel guide CG may serve as a locking protrusion 406 that prevents (or at least mitigates) the separation of the fixing hook 450 from the hook groove HG.

The fixing hook 450 may include a channel burying portion 451 for burying the channel guide CG and a wing (flange) 452 at an end of the channel burying portion 451. The wing 452 may have a variable thickness (e.g., a taper) and may be received in the hook groove HG. The wing 452 may extend upward and downward and together the wing 452 and the channel burying portion 451 may have an arrow shape.

The channel burying portion 451 is inserted into the channel guide CG to guide the wing 452 to the hook groove HG, and the wing 452 is buried in the hook groove HG with a size larger than that of the channel burying portion 451.

Thus, the wing 452 may come into contact with the locking protrusion 406 inside the hook groove HG, thereby preventing (or at least mitigating against) the wing 452 from being separated from the hook receiving recess HR. Accordingly, the fixing hook 450 and the transfer rib 400b can be reliably secured together.

In one or more embodiments, a thickness t of the channel wall 405 is configured to be substantially equal to a gap g between the guide rail GL and the channel burying portion 451.

Accordingly, when the first transfer block 410b moves along the guide rails GL to engage with the fuse bar 300, the fixing hook 450 at the end of the guide rail GL is received (e.g., automatically received) in the hook receiving recess HR.

During the movement of the channel burying portion 451 along the channel guide CG, the wing 452 is inserted into the channel burying portion 451 (e.g., the wing 452 is elastically compressed through the channel burying portion 451), and when the wing 452 reaches the hook groove HG, the compressive force exerted by the channel burying portion 451 is eliminated, and the wing 452 is restored by the elasticity of the wing 452 to be positioned inside the hook groove HG (e.g., the wing 452 is resiliently deformable).

The restored wing 452 is supported by the locking protrusion 406 defining the hook groove HG, thereby preventing (or at least mitigating against) the fixing hook 450 from being separated from the hook receiving recess HR. Accordingly, the first transfer block 410b may be fixed to the boundary holder 221 and the fuse bar 300 engaged with the first transfer block 410b may also be fixed to the boundary holder 221.

The fixing hook 450 may be engaged with the second transfer block 420b in the same way as the fixing hook 450 is engaged with the first transfer block 410b, and therefore any further descriptions of the engagement of the fixing hook 450 and the second transfer block 420b will be omitted.

According to the battery module 500 as described above, by positioning the fixing unit 400 that fixes the fuse bar 300 onto the busbar holder 220 that covers the top of the battery array 100 and holds the busbar 210, the fuse bar 300 may be fixed to the busbar holder 220 without the need for a separate holder.

Thus, an additional fixing unit is not required to fix the fuse bar, which can improve the manufacturing efficiency of the battery module.

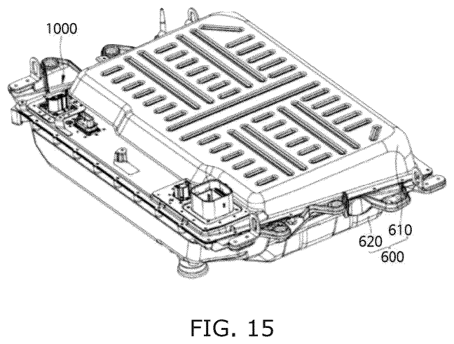

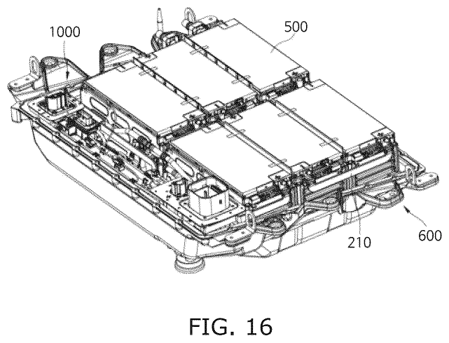

FIG. 15 is a top perspective view showing a battery pack 1000 including the battery module 500 shown in FIG. 1, and FIG. 16 is a rear perspective view showing the battery pack 1000 including the battery module 500 shown in FIG. 1.

Referring to FIGS. 15 and 16, a battery pack 1000 according to one embodiment of the present disclosure may include a plurality of battery modules 500 and a housing 600 for accommodating the battery modules 500.

In one or more embodiments, the housing 600 may include upper and lower housings 610 and 620 that are coupled to face each other to accommodate the plurality of battery modules 500.

The battery modules 500 may be arranged in any suitable or appropriate number depending on the required output. The plurality of battery modules 500 may be electrically connected to each other using the bus bar 210, and the plurality of battery modules 500 may be electrically connected to each other in series, parallel, or a combination of series and parallel to achieve the required electrical output.

In one or more embodiments, each battery module 500 is arranged to include at least one pair of the first cell row 110 and the second cell row 120 in which a plurality of unit cells 90 are connected in series. The pair of the first cell row 110 and the second cell row 120 are connected in series through the fuse bar 300 at the boundary holder 221 located between the first cell row 110 and the second cell row 120.

Accordingly, the plurality of unit cells 90 included in the battery pack 1000 may all be electrically connected. In response to an overcurrent or an inrush current applied to each battery module 500, the fuse bar 300 may disconnect the electrical connection between the first cell row 110 and the second cell row 120 to prevent (or at least mitigate) damage to the battery module 500.

The fixing unit 400 is configured to fix the fuse bar 300 to the busbar holder 220 without the need for separate fixing members for fixing the fuse bar 300.

As the battery module 500 has substantially the same configuration as the battery module 500 described with reference to FIGS. 1 to 14, further details of the battery module 500 will be omitted.

According to the battery module and the battery pack as described above, by including the fixing unit 400 that fixes the fuse bar 300 onto the busbar holder 220 that covers the top of the battery array 100 and holds the busbar 210, the fuse bar 300 may be fixed to the busbar holder 220 without the need for a separate holder.

This eliminates the need for additional fixing units to fix the fuse bar, thus increasing the process efficiency of the battery module or the battery pack.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SOME REFERENCE SYMBOLS

| | |
|---|---|
| 100: battery array | 90: unit cell |
| 200: busbar assembly | 210: busbar |
| 220: busbar holder | 300: fuse bar |
| 400: fixing unit | 500: battery module |
| 600: housing | 1000: battery pack |

1 What is claimed is:

1. A battery module comprising:
a battery array comprising at least two cell rows each comprising a plurality of unit cells arranged in series along a first direction, wherein the at least two cell rows are arranged in parallel along a second direction perpendicular to the first direction;
a busbar assembly comprising a plurality of busbars connecting the plurality of unit cells in each of the at least two cell rows and a busbar holder fixing the plurality of busbars;
a fuse bar on the busbar holder at a boundary region of adjacent cell rows of the at least two cell rows, the fuse bar being configured to electrically connect adjacent unit cells of the adjacent cell rows in the second direction and to block an overcurrent exceeding a set value from being drawn from one of the adjacent cell rows into another one of the adjacent cell rows; and
a fixing unit fixing the fuse bar to the busbar holder at the boundary region.

2. The battery module as claimed in claim 1, wherein the plurality of unit cells comprises positive electrode terminals and negative electrode terminals spaced apart from each other in the second direction, and
wherein, in each of the at least two cell rows, the positive electrode terminals and the negative electrode terminals are alternately arranged in the first direction.

3. The battery module as claimed in claim 2, wherein the plurality of busbars connect the positive electrode terminals and the negative electrode terminals of adjacent unit cells of the plurality of unit cells in the first direction to serially connect the plurality of unit cells of each of the at least two cell rows.

4. The battery module as claimed in claim 3, wherein the fuse bar is connected to a positive electrode terminal of one of the adjacent unit cells and a negative electrode terminal of another one of the adjacent unit cells to serially connect the adjacent cell rows of the at least two cell rows.

5. The battery module as claimed in claim 4, wherein the fuse bar comprises:
a fuse terminal comprising a fuse connected to a positive terminal of one of the adjacent cell units, the fuse being configured to be cut by an overcurrent;
a detection resistor connected to a negative terminal of another one of the adjacent cell units;
a fuse controller configured to detect an intensity of current applied to the adjacent unit cells from the detection resistor and to selectively generate a fuse operation signal based on the intensity of the current; and
a fuse driver configured to drive the fuse terminal to cut the fuse in response to the fuse operation signal.

6. The battery module as claimed in claim 1, wherein the fixing unit engages a pair of fixing side portions of the fuse bar symmetrically positioned along the first direction, the pair of fixing side portions fixing the fuse bar to a boundary holder at the boundary region.

7. The battery module as claimed in claim 6, wherein the fixing unit includes a flat plate rib having a pair of plate blocks fixed to the boundary holder and engaged with the pair of side portions of the fuse bar, the fuse bar being in a space between the pair of plate blocks.

8. The battery module as claimed in claim 7, wherein each of the plate blocks comprises:
a body secured to the boundary holder;
a pair of fixing protrusions protruding along the first direction from a periphery of the body, the pair of fixing protrusion forming a rib receiving recess; and
fixing members protruding through at least one of the pair of fixing protrusions and the body, the fixing members being fixed to the boundary holder,
wherein the fuse bar comprises receiving grooves at the fixing side portions at positions corresponding to positions of the pair of fixing protrusions, and a fuse receiving end defining the receiving grooves and in the rib receiving recess.

9. The battery module as claimed in claim 8, wherein the fixing members comprises bolts fastened to the boundary holder.

10. The battery module as claimed in claim 6, wherein the fixing unit includes a transfer rib having a pair of transfer blocks configured to move linearly along guide rails extending along opposite edges of the boundary holder in the first direction, the pair of transfer blocks being configured to engage the fixing side portions of the fuse bar on the boundary holder.

11. The battery module as claimed in claim 10, wherein each of the transfer blocks comprises:
a body;
a pair of fixing protrusions protruding along the first direction from a periphery of the body, the pair of fixing protrusions forming a rib receiving recess; and
drive members fixed to respective rear surfaces of the body and the pair of fixing protrusions to engage with the guide rails and configured to move the body and the pair of fixing protrusions along the first direction,
wherein the fuse bar comprises receiving grooves at the fixing side portions at positions corresponding to positions of the pair of fixing protrusions, and a fuse receiving end defining the receiving grooves and in the rib receiving recess.

12. The battery module as claimed in claim 11, wherein:
the guide rails are on the opposite edges of the boundary holder,
the drive members have end grooves at opposite sides of at least one of the pair of fixing protrusions and the body, and
the drive members engage the guide rails and receive the guide rails in the end grooves.

13. The battery module as claimed in claim 11, wherein each of the guide rails comprises a fixing hook coupled to an end of corresponding one of the guide rails, and the transfer rib comprises a hook receiving recess receiving the fixing hook,
wherein the transfer rib is fixed to the guide rails by engagement of the fixing hook and the hook receiving recess.

14. The battery module as claimed in claim 13, wherein the hook receiving recess comprises:
a channel guide linearly recessed along the first direction from a lower outer surface of each of the pair of fixing protrusions and defined by a channel wall;
a hook groove at an end of the channel guide in communication with the channel guide, the hook groove having a size larger than the channel guide; and
a locking protrusion that is a step with respect to the channel guide, the locking protrusion being configured to prevent separation of the fixing hook in the hook groove.

15. The battery module as claimed in claim 14, wherein the fixing hook comprises a channel burying portion in the channel guide and a wing at an end of the channel burying portion, the wing having a variable thickness and being in the hook groove.

16. The battery module as claimed in claim 15, wherein a thickness of the channel wall is substantially equal to a gap between each of the guide rails and the channel burying portion.

17. A battery pack comprising:
a plurality of battery modules in a lower housing and electrically connected to each other; and
an upper housing coupled to the lower housing to separate the plurality of battery modules from an outside,
wherein each of the battery modules comprises:
a battery array comprising at least two cell rows each comprising a plurality of unit cells arranged in series along a first direction, wherein the at least two cell rows are arranged in parallel along a second direction perpendicular to the first direction;
a busbar assembly comprising a plurality of busbars connecting the plurality of unit cells in each of the at least two cell rows and a busbar holder fixing the plurality of busbars;
a fuse bar on the busbar holder at a boundary region of adjacent cell rows of the at least two cell rows to electrically connect adjacent unit cells of the adjacent cell rows in the second direction and to block an overcurrent exceeding a set value from being drawn from one of the adjacent cell rows to another one of the adjacent cell rows; and
a fixing unit fixing the fuse bar to the busbar holder at the boundary region.

18. The battery pack as claimed in claim 17, wherein the fixing unit engages a pair of fixing side portions of the fuse bar symmetrically positioned along the first direction, the fixing unit fixing the fuse bar to a boundary holder at the boundary region.

19. The battery pack as claimed in claim 18, wherein the fixing unit includes a flat plate rib having a pair of plate blocks fixed to the boundary holder and engaged with the pair of side portions of the fuse bar, and wherein the fuse bar is in a space between the pair of plate blocks

20. The battery pack as claimed in claim 18, wherein the fixing unit includes a transfer rib having a pair of transfer blocks configured to move linearly along guide rails extending along opposite edges of the boundary holder in the first direction, the pair of transfer blocks being configured to engage with each of the fixing side portions of the fuse bar aligned on the boundary holder.
